(19) United States
(12) Patent Application Publication
(10) Pub. No.: US 2004/0099203 A1
(43) Pub. Date: May 27, 2004

(54) Critical temperature indicator

(76) Inventor: Robert Parker, Bend, OR (US)

Correspondence Address: ROBERT PARKER, 60617 GOLE VILLAGE LOOP, BEND, OR, 97702, US

(21) Appl. No.: 10/703,705

(22) Filed: Nov. 5, 2003

Related U.S. Application Data
(60) Provisional application No. 60/425,072, filed on Nov. 7, 2002.

(51) Int. Cl. G01K 1/02

(52) U.S. Cl. 116/216

(57) ABSTRACT

A critical temperature indicator is provided using inexpensive molded vessels and filled with water sealed with a deformable membrane that will, upon reaching freezing, expand and cause the membrane coated with a transferable pigment to contact a spacer cap and give an irreversible indication.

A critical temperature indicator is provided using molded inexpensive vessels filled with organic compounds that have a volume reduction as they undergo a change from the liquid state to a solid state. Either a spring-loaded diaphragm or a cylinder syringe-like assembly is used to move and show the volume change in conjunction with a transferable pigment to provide an irreversible color change when the organic compound turns into a solid. A dark pigmented rubber may be used instead of the transferable pigment so the device can be reversible.

### BACKGROUND OF THE INVENTION

1. Technical Field of the Invention

This invention relates to critical temperature indicators, more particularly to critical temperature indicators which provide an irreversible visual signal to the user that a product has been exposed to a predetermined temperature, usually near the freezing point of water.

2. Description of the Prior Art

Blood, emulsions, pharmaceuticals, beverages, and other items are often chilled in order that they may be preserved for use sometime later. However, the characteristics of these items may change so that they are undesirable for later-use or be rendered completely useless if exposed to a lower temperature, usually the freezing point of water. It is, therefore, desirable to provide an indicator device which will accurately show whether or not the temperature of an item or the ambient temperature has decreased below a critical value. It is also desirable that the device provide its indication rapidly and that the indication be irreversible so that the user will be alerted to a past frozen condition, even if that condition does not presently exist.

Many critical temperature indicators have been provided which utilize the expansion characteristics of water to break a frangible ampule as, for example, Couch ET AL U.S. Pat. No. 4,145,918. Once the device shown in the Couch ET AL patent is exposed to temperatures below the freezing point of water, the volume increase as the water changes to ice causing large internal pressures and the ampule breaks. After the ice has formed and after the ambient temperature is above freezing, the water is absorbed by a dye-loaded pad, giving an irreversible color change showing that the device experienced a freeze/thaw cycle.

Water constrained in a small volume can experience super cooling and cause the water to freeze at temperatures below 0° C. or 32° F. This problem can be partially solved by the addition of a nucleating agent as disclosed in U.S. Pat. No. 4,191,125 by Johnson.

Another device invented by Wendell J. Manske, U.S. Pat. No. 4,457,252 uses a complex arrangement of organic compounds such as butyl myristate that decrease in volume when going from a liquid to a solid, thus causing a void which allows another organic compound, which is still a liquid, to be drawn past a plug or liquid separator along with a dye which causes a color change. This is a complex structure which is not easy to produce in an inexpensive manner. A glass bulb and capillary system is subject to breakage from shock and vibration and must be protected with a thick foam cushion which can slow heat transfer to the indicating device and cause additional cost. It will not show how hard a freeze occurred.

### SUMMARY OF THE INVENTION

The present device uses a plastic vacuum formed, or injection molded, or metal vessel or reservoir which is filled with water or other materials. This liquid is sealed hermetically with a thin deformable membrane. The change in volume of the liquid as it goes through a phase change when it is exposed to some critical temperature will cause the membrane to move through a void space and contact a frosted transparent cap causing the transfer of a pigmented adhesive or pigmented grease or ink to be irreversibly deposited and causing a change from white or clear to any color depending on the pigmentation. A colored label may also be transferred to give an irreversible color change. A similar concept may be employed using an organic material that decreases in volume. This device is inexpensive to produce and because of the contact area may show how hard a freeze occurred. This device may also be used as a reversible indicator.

### BRIEF DESCRIPTION OF THE DRAWINGS

FIG. 1 Top view of a conical cap filled with a liquid that will expand when freezing to move a deformable membrane upwards to contact a cap.

FIG. 2 shows a cross-sectional view along Line I-I of FIG. 1.

FIG. 3 shows the top view of the device in FIG. 1 when the fluid is in the frozen state.

FIG. 4 shows a cross-sectional view along Line II-II of FIG. 3.

FIG. 5 shows the top view of a vessel that has the shape of a torroid with a conical cross section.

FIG. 6 shows a cross-sectional view along Line III-III of FIG. 5.

FIG. 7 shows the top view of a spring-loaded assembly that uses an organic compound such as butyl myristate or wax that will contract when cooled from a liquid to a solid.

FIG. 8 shows a cross-sectional view along Line IV-IV of FIG. 7.

FIG. 9 shows the top view of FIG. 8 after exposure to a freezing environment. Note the irreversible indication.

FIG. 10 shows a cross-sectional view along Lines V-V of FIG. 9.

FIG. 11 shows the top view of an assembly using the Expansion of a material in a very small cylindrical/conical assembly with a moveable disc forced upward by a flexible membrane.

FIG. 12 shows the cross-section along Line VI-VI of FIG. 11.

FIG. 13 shows the top section of FIG. 11 after a critical temperature has been reached. Note the irreversible indication.

FIG. 14 shows the cross-section along Line VII-VII of FIG. 13.

FIG. 15 is a top view of an assembly using an organic compound in a cylindrical assembly when the organic material is in the liquid state.

FIG. 16 shows the cross-section along Line VIII-VIII in FIG. 15.

FIG. 17 shows the top view of an assembly described in FIG. 15 when an organic compound is in the solid state.

FIG. 18 shows the cross-section along Lines IX-IX when the organic material is in a solid state.

### DETAILED DESCRIPTION OF THE INVENTION

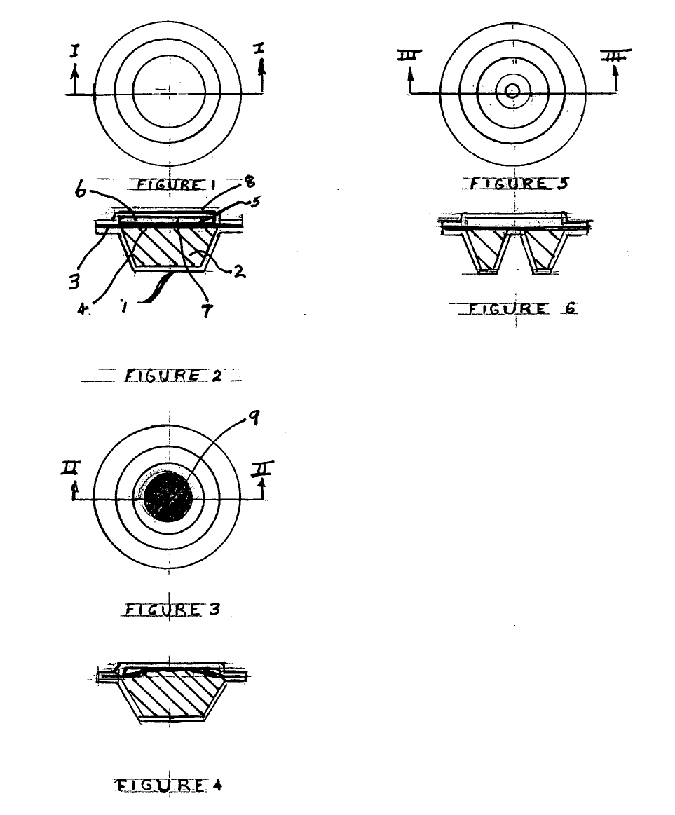

Referring to FIG. 2, there is shown a critical temperature indicator about the size tested. The vessel, generally indicated by the numeral 1 may be a vacuum formed or injection molded plastic using polyethylene, polycarbonate ABS or other preferably transparent plastics. After much experimentation, it was determined that a conical shape gave rise to a frozen dome, although other shapes also worked, such as cylinders. Metal vessels may also be used, but thin wall 0.020-0.040″ (but not limited to these thicknesses) thick plastics is preferred. Plastic will shrink 30-60×10⁻⁶ in/in 0° C. which further squeezes the expansion of the water as it starts to freeze. This thin wall enhances heat transfer. The vessel is filled with water 2 or water with a nucleating agent, such as cupric sulfide powder, to increase the freezing point temperature or various salts, such as sodium chloride, to reduce the freeze temperature.

The water is hermetically sealed in the vessel using a thin aluminum membrane (about 0.0005-0.002″) foil with 3 preferably hot melt adhesive or pressure sensitive adhesive along the edge of the vessel. Little or no air is present in the water. Other membrane materials include latex, saran polyethylene, etc. A silicone release coating may be applied to the top of the membrane 4 and a pigmented “Black” or other color pressure sensitive adhesive may be coated on top of the release material. Acrylic adhesives or others may be used 5.

In addition to adhesives, it is also possible to die-cut a small disc or label with one side bonded to the diaphragm with a poor adhesive and the other side with a strong adhesive. This label can be made of paper or plastic film pigmented with some color. This disc would be transferred upon contact to the inside surface of the frosted surface resulting in an irreversible significant color change from white to some color.

Other coatings that will also work include pigmented grease 5. Another material that may be used is a film that changes color under compression sold by Sensor Products Inc., in East Hanover, N.J. The adhesive (pigment) and pigmented oil or non-drying materials are preferred. Bonded to the edge of the cup, either by hot adhesive, pressure sensitive adhesive or ultrasonic bonding, is a cap made of transparent plastic, whether vacuum formed or injection molded from a clear plastic. There is a space between the membrane and the bottom of the cap which was 0.015″ where the vessel was ⅜″ high. The underside 7 or the side near the membrane has a rough frosted surface so that when looking through the smooth surface 8 one would see a white or milky color from the light scattering sights.

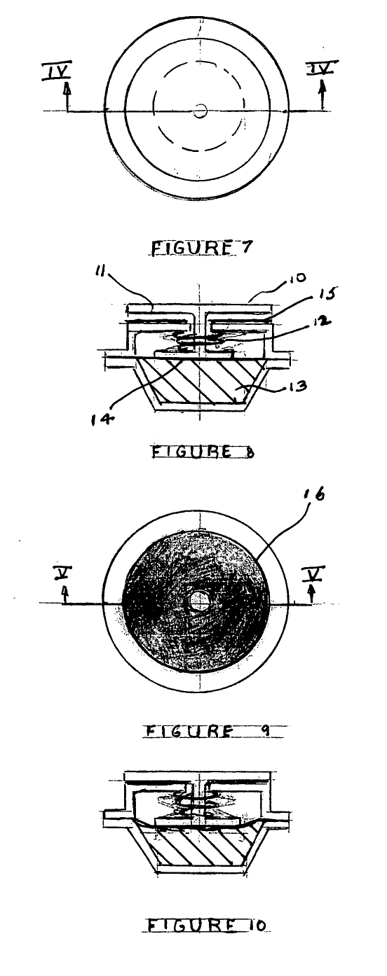

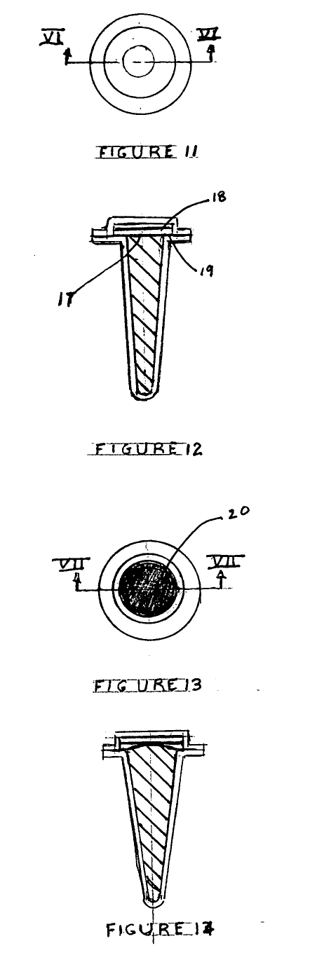

When the indicator is in a freezing environment, the water will expand as shown in FIG. 4 and will make contact with the frosted surface 7 and permanently transfer the pigmented adhesive or oil or colored label to that surface. Because the frosted surfaces becomes wet, there will be a high contrast color change from white to the pigmented color 9—as shown in FIG. 3 and in fact, it may be possible to determine how hard a freeze occurred by the size of the spot “9”.

In FIGS. 5 and 6 an alternative design is shown where there is more surface area for heat transfer and less volume of water resulting in faster response times.

While these devices were built and tested, it is clear that smaller or larger devices would also work.

It is also possible to make this device with a cap that can be attached later so that it can be shipped and stored at very low temperatures without triggering the device.

FIGS. 7 and 8 show a similar vessel filled with an organic compound, such as butyl myristate or sharp melting point wax 13. Again, a deformable membrane 14 is used to hermetically seal the fluid 13.

A spring 12 loaded plunger 10 is pushed against the surface of the membrane; however, the membrane will not deform, because the volume of the liquid will maintain the surface and the membrane near the edges are constrained. A transferable pigmented material is placed as shown. A frosted surface is shown on 11. The table shown in Manske U.S. Pat. No. 4,457,252 shows the freeze points of various organic compounds.

When the unit is exposed to a freezing environment, the membrane 14 will move downward as shown in FIG. 9, because the volume will shrink 8-9% and the spring will allow the plunger to follow. The frosted surface 11 will make contact with the colored pigment 15 to provide a permanent color change as shown in 16 of FIG. 9 or transfer a pigmented label.

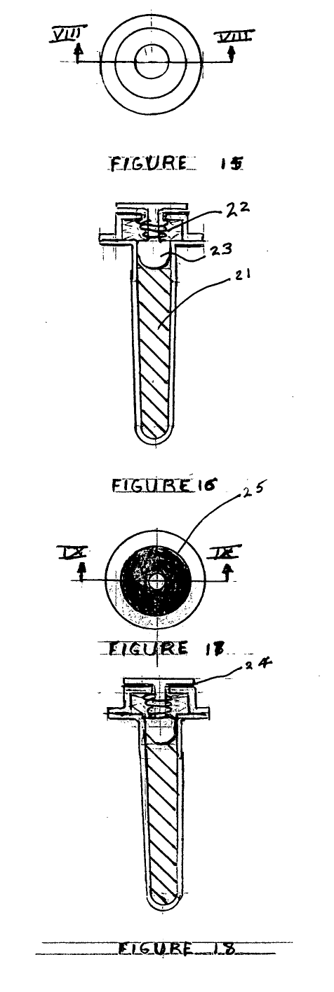

FIG. 12 shows another configuration of critical temperature indicator using a small volume of liquid (water) and a membrane system 17. The advantage of this design is that there is less volume of water and more surface area for heat transfer and thus a more rapid response to ambient temperatures. It also has a longer column of water which will give more displacement to the membrane. The materials used are similar to those discussed in FIG. 2. The design is slightly different in that a thick 0.020″ disc 18 with the pigment transferring material or label is glued with a poor glue at the edges circumference 19. When the water freezes the membrane pushes the disc 18 in contact with the cup surface as shown in FIG. 14. The color change 20 is shown in FIG. 13. This will give a larger surface area of color change and wedge the disc in place.

FIG. 16 and FIG. 18 show a spring load cylinder or syringe plunger in a vessel filled with an organic compound such as butyl myristate 21 which decreases volume when exposed to 0° C. or 32° F. or less. A spring 22 will put force on the cylinder/plunger plug 23. When shrinkage occurs at 32° F. the plug or plunger will move down causing the surface 24 to contact the colored pigment resulting in a color change 25 in FIG. 17. All of these devices could have pressure sensitive adhesive to attache them to a box or shipping materials.

The units in FIG. 16 and FIG. 18 may also be used in reversible applications, for example using cetyl palmitate which solidifies at 20.2° F. or 49° C. and higher temperatures or high sharp melting point waxes. Instead of a transferable adhesive or label, one may use a soft-pigmented silicon rubber so that at temperature below the freeze temperature the soft rubber will contact the frosted under-surface which will color the surface as in FIG. 17. When the organic compound melts, the plunger will be forced downward as the material shrinks, causing the color to appear white as in FIG. 15. This concept can be used repeatedly so that certain cooking situations, such as cooking fowl; one may use this concept to determine the doneness of the food.

These devices are inexpensive to produce and assemble because unlike the complexity of the prior art injection or vacuum formed plastic and print technology are inexpensive and designed for efficient mass production, as opposed to complex glass assemblies. It also provides a clear easily visible dramatic color change for the potential user. Because of the plastic materials used, the indicator devices are less subject to breakage from shock or vibration. The concepts described also allow for either organic compounds such as butyl myristate, wax or water to be used. Only one active component material is used for expansion and contraction as opposed to the use of two liquid materials and a dyed compound, along with a separator in the prior art.

The critical temperature is indicated without a thawing or increase in temperature.

From the foregoing descriptions of the exemplified embodiments, it will be apparent that many modifications may be made therein. It will be understood, therefore, that the embodiments are intended as illustrations of the invention only and that the invention is not limited thereto. It is intended in the appended claims to cover all such modifications as fall within the true scope of the invention.

I claim:

1. Apparatus for indicating a critical temperature, comprising
a vessel filled with a liquid that undergoes a phase change at a critical temperature; and
a deformable diaphragm sealing the liquid in the vessel, the phase change deforming the diaphragm and thereby indicating the critical temperature.

2. The apparatus of claim 1 wherein the liquid expands the diaphragm at the phase change.

3. The apparatus of claim 1 wherein the liquid contracts the diaphragm at the phase change.

4. The apparatus of claim 1 further including a cap that is engaged by the deformation of the diaphragm and thereby indicating the critical temperature.

5. The apparatus of claim 4 wherein the deformation of the diaphragm is proportional to the temperature drop that the liquid under went below the critical temperature, thereby indicating how hard a freeze occurred.

6. The apparatus of claim 1 further including means within the liquid for changing the temperature of the phase change.

7. The apparatus of claim 1 where the vessel has the shape of a frustum of a cone, said cone having a larger diameter and a smaller diameter, and the diaphragm seals the area with the larger diameter.

8. The apparatus of claim 1 wherein the vessel has the shape of a torroid with a cross section of a frustum of a cone.

9. The apparatus of claim 1 wherein the vessel has the shape of an elongate cone having a large diameter at one end and the diaphragm seals the area with the large diameter.

10. Apparatus for indicating a critical temperature, comprising:
a vessel filled with a liquid that undergoes a phase change at a critical temperature;
a deformable diaphragm sealing the liquid in the vessel; and
a cap having an inner wall that is frosted and that is engaged by the deformation of the diaphragm and thereby indicating the critical temperature.

11. The apparatus of claim 10 further including a layer of grease on the diaphragm that is deposited on the frosted inner wall at the critical temperature, thereby overcoming the frosting and enabling the diaphragm to be seen through the cap.

12. Apparatus for indicating a critical temperature, comprising:
a vessel filled with a liquid that undergoes a phase change at a critical temperature;
a deformable diaphragm sealing the liquid in the vessel and having a wall;
an adhesive on said wall; and
a cap having a color and having an inner wall that is engaged by the deformation of the diaphragm so that at the at the critical temperature the color of the cap.

13. Apparatus for indicating a critical temperature, comprising:
a vessel filled with a liquid that undergoes a phase change at a critical temperature,
a deformable diaphragm sealing the liquid in the vessel and having a wall;
an adhesive label on said wall; and
a cap having an inner wall that is engaged by the deformation of the diaphragm so that the critical temperature the label is adhesively deposited on the inner wall of the cap where the label can be seen.

14. Apparatus for indicating a critical temperature, comprising:
a vessel filled with a liquid that undergoes a phase change at a critical temperature;
a deformable diaphragm sealing the liquid in the vessel, the phase change deforming the diaphragm;
a piston urged against the diaphragm by a spring; and
a cap that is engaged at the critical temperature by the piston and marked thereby.

15. Apparatus for indicating a critical temperature comprising:
a vessel filled with a liquid that undergoes a phase change at a critical temperature;
a piston urged against the liquid by a spring; and
a cap that is engaged at the critical temperature by the piston and marked thereby.
